(19) United States
(12) Patent Application Publication
(10) Pub. No.: US 2019/0073045 A1
(43) Pub. Date: Mar. 7, 2019

(54) KEYSET FINGERPRINT SENSOR

(71) Applicant: Microsoft Technology Licensing, LLC, Redmond, WA (US)

(72) Inventors: Pengfei LEI, Shenzhen (CN); Jianxin JU, Beijing (CN); Nicolas J.C. SCHMITT, Beijing (CN); YuJian PENG, Beijing (CN); Tianyi WANG, Beijing (CN); Vicky CHEN, Beijing (CN); Zhongping XIAO, Beijing (CN); Rafl ZHANG, Beijing (CN)

(73) Assignee: Microsoft Technology Licensing, LLC, Redmond, WA (US)

(21) Appl. No.: 16/083,593

(22) PCT Filed: Apr. 1, 2016
(86) PCT No.: PCT/CN2016/078261

§ 371 Date: Sep. 10, 2018

(51) Int. Cl. G06F 3/02; G06K 9/00; H01H 13/83; H01H 13/705

(52) U.S. Cl. CPC G06F 3/021; G06F 3/0219; H01H 13/705; H01H 13/83; G06K 9/00006

(57) ABSTRACT

Keyset fingerprint sensors integrated within a keyset of an input device are described herein. A sensor key having an integrated fingerprint sensor is included within an arrangement of keys rather than being provided as a separate or external component. The fingerprint sensor operates to capture fingerprint data and initiate recognition processing responsive to actuation of the sensor key. In implementations, the cover includes a cut-out exposes the underlying fingerprint sensor so the fingerprint sensor is visible through an opening in the surface the key. Alternatively, the cover forms a surface designed to conceal the underlying fingerprint sensor. In this approach, the sensor key matches other keys within the arrangement of keys, such that the sensor key “blends-in” and is not visible from the surface of the key. In implementations, the sensor key includes a rigid PCB layer having fingerprint sensor componentry mounted to the PCB layer.

### BACKGROUND

A variety of kinds of computing devices have been developed to provide computing functionality to users in different settings. For example, a user may interact with a mobile phone, tablet computer, wearable device or other computing device to check email, surf the web, compose texts, interact with applications, and access other resources. The use of biometric technology to facilitate user access to their devices and/or authentication to access resources is increasing due to security demands and potential for biometric technology to make access and authentication quick and easy. Today, fingerprint sensing technology is a widely used form of biometric technology and various types of fingerprint sensors are available.

In traditional arrangements, fingerprint sensors used with some devices are provided as separate external devices, such as USB peripheral sensors. However, the external fingerprint sensors require users to keep track of and manage an additional item and carry the item along in mobile scenarios. As such, users may find the external fingerprint sensors inconvenient and may be reluctant to adopt the technology. Other devices have recently appeared having built-in fingerprint sensors, but typically the built-in fingerprint sensors are designed as additional, separate components (e.g., a dedicated sensor button or control) that take-up additional space within a device housing as well as on the exposed device surfaces. Consequently, the addition of a built-in fingerprint sensor places constraints on device size that make it difficult for developers to create thin and sleek designs that are popular with consumers.

### SUMMARY

Designs and techniques for keyset fingerprint sensors are described herein. In one or more implementations, a fingerprint sensor is integrated within a keyset of an input device. For instance, a key within an arrangement of keys (e.g., “a keyset”) for a keyboard is adapted to operate as a sensor key having an integrated fingerprint sensor. The sensor key is included within the arrangement of keys rather than being provided as a separate or external component. In implementations, a keycap for the sensor key is configured to include a cover having an integrated fingerprint sensor. The fingerprint sensor operates to capture fingerprint data and initiate recognition processing responsive to actuation of the sensor key. In implementations, the cover is configured to include a cut-out portion positioned above the fingerprint sensor such that the fingerprint sensor within the key is exposed and visible through an opening formed by the cut-out in the surface of the sensor key. Alternatively, the cover is configured to form a surface for the sensor key that covers the underlying fingerprint sensor. In this approach, the sensor key has an appearance that matches other keys within the arrangement of keys, such that the sensor key “blends-in” and the embedded fingerprint sensor is not visible from the surface of the key. In implementations, the sensor key includes a rigid PCB layer having fingerprint sensor componentry mounted to the PCB layer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example operating environment that is operable to employ the keyset fingerprint sensors described herein in accordance with one or more implementations.

FIG. 2 depicts an example implementation of an input device of FIG. 1 in greater detail.

FIG. 3 depicts details of an example sensor key included in a keyset assembly for an input device in accordance with one or more implementations.

FIG. 4 depicts an example arrangement of a keycap in accordance with one or more implementations.

FIG. 5 depicts another example arrangement of a keycap in accordance with one or more implementations.

FIG. 6 depicts another example arrangement of a keycap in accordance with one or more implementations.

FIG. 7 depicts an example backlight arrangement for keyset fingerprint sensors in accordance with one or more implementations.

FIG. 8 depicts an example procedure for assembly of an input device having a keyset fingerprint sensor in accordance with one or more implementations.

FIG. 9 illustrates an example system that includes an example computing device that is representative of one or more computing systems and/or devices that may implement the various techniques described herein.

### DETAILED DESCRIPTION

### Overview

Conventional fingerprint sensors used with some devices are provided as separate external devices or built-in as additional, separate components (e.g., a dedicated sensor button or control) that take-up additional space within the device housing. As such, users may find fingerprint sensors inconvenient to use and device size is comparatively large for devices that include conventional fingerprint sensor designs.

Designs and techniques for keyset fingerprint sensors are described herein. In one or more implementations, a fingerprint sensor is integrated within a keyset of an input device. For instance, a key within an arrangement of keys (e.g., “a keyset”) for a keyboard is adapted to operate as a sensor key having an integrated fingerprint sensor. The sensor key is included within the arrangement of keys rather than being provided as a separate or external component. The key may be implemented as an operable key that moves or a fixed key used for sensing that looks like other keys in the arrangement. In implementations, a keycap for the sensor key is configured to include a cover having an integrated fingerprint sensor. The fingerprint sensor operates to capture fingerprint data and initiate recognition processing responsive to actuation of the sensor key. In implementations, the cover is configured to include a cut-out portion positioned above the fingerprint sensor such that the fingerprint sensor within the key is exposed and visible through an opening formed by the cut-out in the surface of the sensor key. Alternatively, the cover is configured to form a surface for the sensor key that covers the underlying fingerprint sensor. In this approach, the sensor key has an appearance that matches other keys within the arrangement of keys, such that the sensor key “blends-in” and the embedded fingerprint sensor is not visible from the surface of the key. In implementations, the sensor key includes a rigid PCB layer having fingerprint sensor componentry mounted to the PCB layer.

Fingerprint sensor arrangements described herein provide convenient location of a sensor key within a key arrangement for an input device. The sensor key is built into a key that is already included in the keyset and accordingly the device size can be optimized, and componentry and cost to add fingerprint sensors is reduced relative to conventional arrangements. In implementations, the same key is configured for use as a both a fingerprint sensor and as a key having other input function(s).

In the discussion that follows, a section titled “Operating Environment” is provided that describes an example environment suitable to employ the keyset fingerprint sensor with backlight techniques described herein. Following this, a section titled “Keyset Fingerprint Sensor Key Examples” describes example techniques, devices, arrangements, and details in accordance with one or more implementations. Last, a section titled “Example System” describes example computing systems and devices that can employ keyset fingerprint sensors in accordance with one or more implementations.

Operating Environment

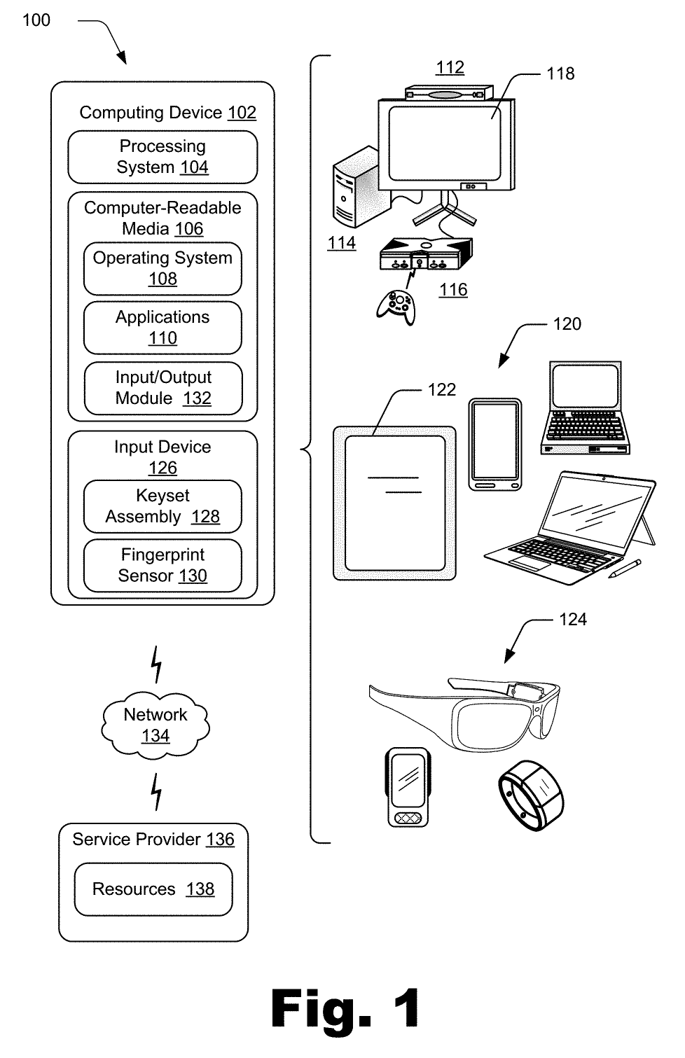

FIG. 1 illustrates an operating environment in accordance with one or more implementations, generally at 100. The environment 100 includes a computing device 102 having a processing system 104 with one or more processors and devices (e.g., CPUs, GPUs, microcontrollers, hardware elements, fixed logic devices, etc.), one or more computer-readable media 106, an operating system 108, and one or more applications 110 that reside on the computer-readable media and which are executable by the processing system. The processing system 104 may retrieve and execute computer-program instructions from applications 110 to provide a wide range of functionality to the computing device 102, including but not limited to gaming, office productivity, email, media management, printing, networking, web-browsing, and so forth. A variety of data and program files related to the applications 110 can also be included, examples of which include games files, office documents, multimedia files, emails, data files, web pages, user profile and/or preference data, and so forth.

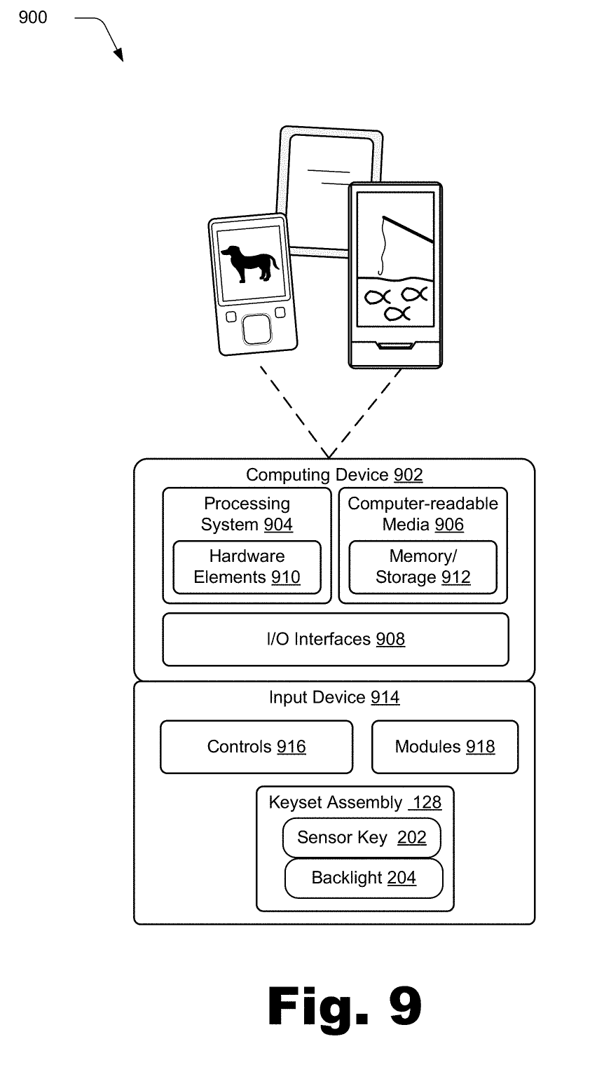

The computing device 102 can be embodied as any suitable computing system and/or device such as, by way of example and not limitation, a gaming system, a desktop computer, a portable computer, a tablet or slate computer, a handheld computer such as a personal digital assistant (PDA), a cell phone, a set-top box, a wearable device (e.g., watch, band, glasses, etc.), and the like. For example, as shown in FIG. 1 the computing device 102 can be implemented as a television client device 112, a computer 114, and/or a gaming system 116 that is connected to a display device 118 to display media content. Alternatively, the computing device may be any type of portable computer, mobile phone, or portable device 120 that includes an integrated display 122. A computing device may also be configured as a wearable device 124 that is designed to be worn by, attached to, carried by, or otherwise transported by a user. Examples of wearable devices 124 depicted in FIG. 1 include glasses, a smart band or watch, and a pod device such as clip-on fitness device, media player, or tracker. Other examples of wearable devices 124 include but are not limited to a ring, an article of clothing, a glove, and a bracelet, to name a few examples. Any of the computing devices can be implemented with various components, such as one or more processors and memory devices, as well as with any combination of differing components. One example of a computing system that can represent various systems and/or devices including the computing device 102 is shown and described below in relation to FIG. 9.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 9.

The computing device 102 may include or make use of an input device 126. For example, the computing device 102 may be communicatively coupled to one or more input device 126 via any suitable wired or wireless connection. Input devices include devices integrated with the computing device 102, such as an integrated keyboard, touchpad, track pad, pointer device, a bezel or other touch operable component of a tablet or wearable device, a touch capable display, and so forth. Input devices also include external devices and removably connectable devices such as a mouse, wireless keyboard, removable keyboard/cover combination, a mobile phone, a wearable device used to control the computing device through a wireless connection, an external touchpad, and so forth. Other non-conventional configurations of an input device are also contemplated, such as a game controller, configuration to mimic a musical instrument, and so forth. Thus, the input device 126 and controls incorporated by the input device (e.g., buttons, keys, touch regions, toggles, etc.) may assume a variety of different configurations to support a variety of different functionality.

In accordance with one or more implementations described herein, an input device 126 includes a keyset assembly 128 that implements a fingerprint sensor 130. As introduced above, the fingerprint sensor 130 is integrated within a key included in an arrangement of keys (e.g., a keyset having one or more individual keys) implemented by the keyset assembly 128. For example, at least one key of an input device 126 in the form of a keyboard may be adapted to operate as a sensor key having an integrated fingerprint sensor. The sensor key is included within the arrangement of keys rather than being provided as a separate or external component. In implementations, a keycap for the sensor key is configured to include a cover having an integrated circuit die and/or other componentry that provides fingerprint sensor functionality. The sensor key may be configured in various ways, examples of which are provided in the discussion that follows.

In general, the fingerprint sensor 130 represents any suitable device and/or electronic componentry used to capture a digital image of fingerprint patterns. The captured fingerprint image is processed to create a template that reflects features of a known fingerprint. Templates associated with different users may be stored and referenced for matching in an authentication or log-in scenario. To do so, a captured image is compared to images encoded by templates for known users to find a match based on feature correspondence between the images. Various different types of fingerprint sensing technologies are contemplated including but not limited to optical, capacitive, RF, thermal, piezoresistive, ultrasonic, piezoelectric, and microelectromechanical systems (MEMS).

Additionally, a backlight integrated with the keyset assembly may be provided to supply light for backlighting of the keyset including backlighting of the sensor key. Backlighting may be employed to selectively illuminate the sensor key in dependence upon the sensors status, current interaction scenario, and/or various corresponding criteria. Details regarding these and other aspects of a keyset assembly 128 can be found in the following discussion.

The computing device 102 is further illustrated as including an input/output module 132 configured to process input signals received from the input device 126 and/or other sources. The input/output module 132 is representative of various functionality relating to processing of inputs and rendering outputs of the computing device 102. A variety of different inputs may be processed by the input/output module 132, such as inputs relating to operation of controls of the input device 126, keys of a virtual keyboard, identification of gestures through touchscreen functionality, and so forth. Responsive to the inputs, the input/output module 132 causes corresponding operations to be performed. Thus, the input/output module 132 may support a variety of different input techniques by recognizing and leveraging a division between types of inputs including key presses, gestures, control interaction, and so on.

The environment 100 further depicts that the computing device 102 may be communicatively coupled via a network 134 to a service provider 136, which enables the computing device 102 to access and interact with various resources 138 made available by the service provider 136. The resources 138 can include any suitable combination of content and/or services typically made available over a network by one or more service providers. For instance, content can include various combinations of text, video, ads, audio, multi-media streams, animations, images, webpages, and the like. Some examples of services include, but are not limited to, an online computing service (e.g., “cloud” computing), an authentication service, web-based applications, a file storage and collaboration service, a search service, messaging services such as email and/or instant messaging, and a social networking service.

Having described an example operating environment, consider now example details and techniques associated with one or more implementations of a sensor key for a keyset.

Keyset Fingerprint Sensor Key Examples

Example Devices and Sensor Key Arrangements

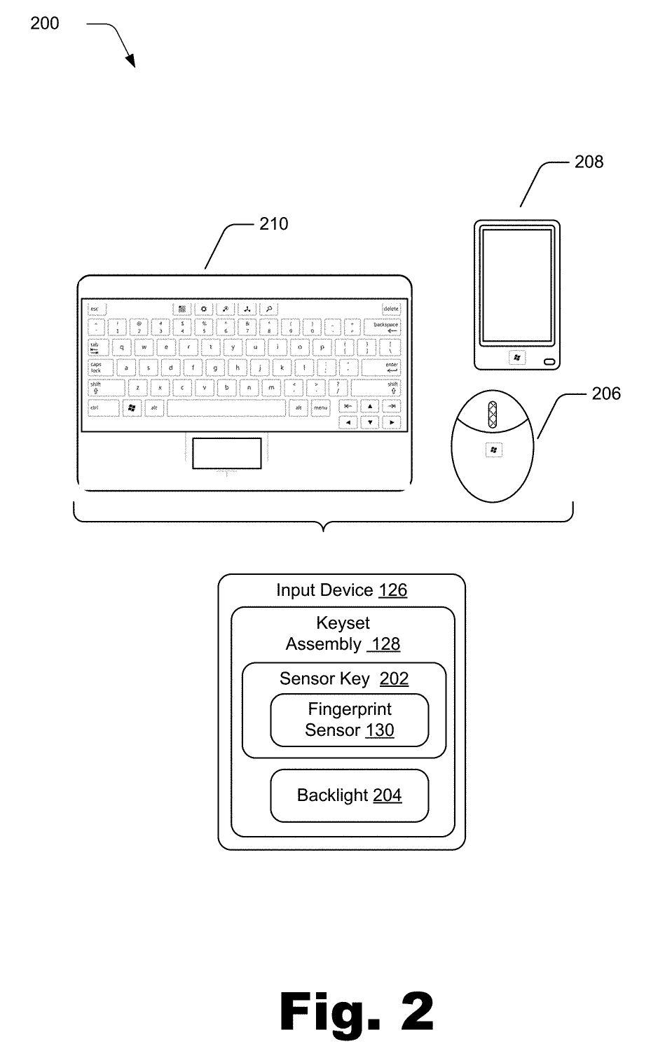

FIG. 2 depicts generally at 200 an example implementation of an input device 126 of FIG. 1 in greater detail. In the illustrated example, the input device 126 includes the keyset assembly 128, which may be configured in various ways as described in this document. The keyset assembly 128 may be configured to provide one or more keys (or other input control mechanisms) for various kinds of devices. Generally, the keyset assembly 128 provides an arrangement of physical buttons or “keys” that act as mechanical levers and/or electronic switches to supply input for a computing device. It is contemplated that the techniques described above and below may be employed with keyset assemblies that use various different technologies to implement and actuate keys. By way of example and not limitation, the keyset assembly 128 may utilize one or a combination of scissors switches, mechanical switches, dome switches, capacitive touch pads, hall effect detectors, and other types of mechanisms used for key travel and key press detection. The keyset assembly 128 may be further designed to produce a tactile feel through mechanical structures and spring action of the keys, using a haptic response to key touches, or otherwise. The key may be implemented as an operable key that moves, or a fixed key used for sensing that looks like other keys in the arrangement.

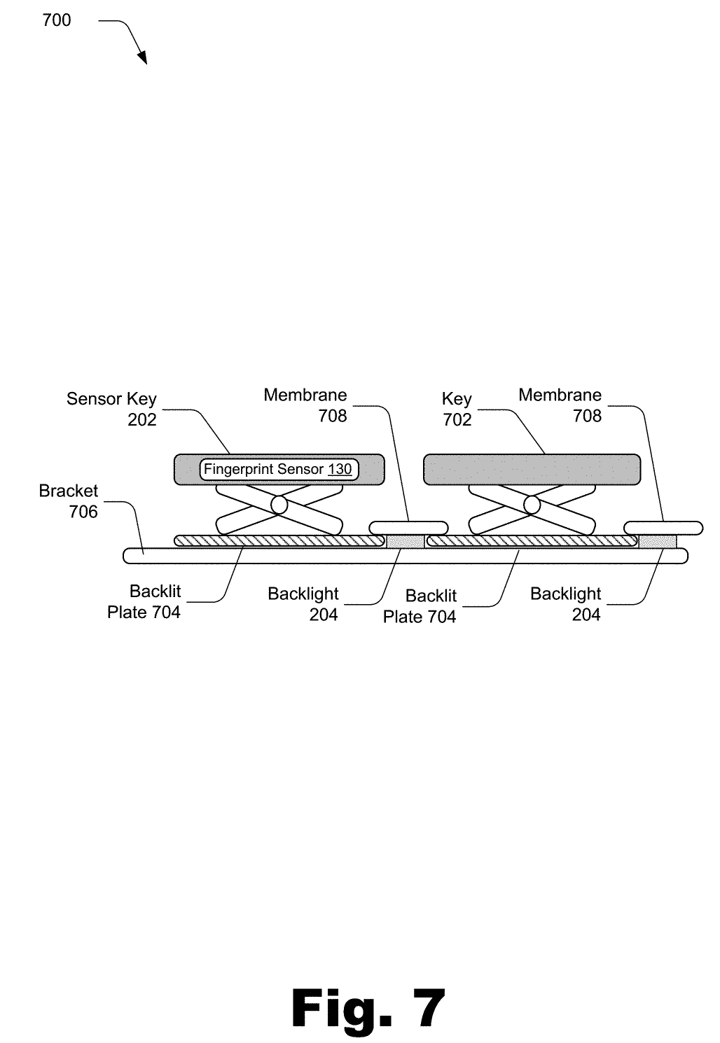

As depicted, the keyset assembly 128 includes a sensor key 202. The sensor key 202 represents a key located within the arrangement of keys that is configured to implement a fingerprint sensor 130 using the techniques described herein. Although a single sensor key 202 is represented, a keyset assembly 128 may include one or more keys in the form of a sensor key 202. The sensor key is shown as including a fingerprint sensor 130, which may be configured and operate in various ways as described above and below. The sensor key 202 may be a dedicated key that has a primary function to perform fingerprint sensing. In addition, or alternatively, the sensor key 202 may be configured as multifunctional key designed for use as a both a fingerprint sensor and as a key having other input function(s). For example, the sensor key 202 may be built into another key such as a letter key, a space bar, a logo or “home” key, or any other key traditionally included in a keyset assembly 128. The keyset assembly 128 may also include a backlight 204 as noted above. Details regarding backlight arrangements and backlighting in conjunction with keyset fingerprint sensors as described are discussed below in relation to FIG. 7.

As noted, the techniques as described in this document may be used to implement various different types of keys and other input controls for various electronic devices. Some illustrative example devices and corresponding controls are represented in FIG. 2. For example, the keyset assembly 128 may be employed to implement a button or buttons for a mouse 206; keys or buttons associated with a mobile device 208, such as a mobile phone, tablet, camera, wearable device, or portable digital media player; keys within an arrangement of keys for a keyboard 210, and/or keys and controls provided by other input devices 126. Moreover, the described techniques may be employed with “keys” as well various other kinds of hardware controls and navigational input sensors including but not limited to capacitive buttons, trackpad devices, capacitive sliders, directional control buttons, and the like.

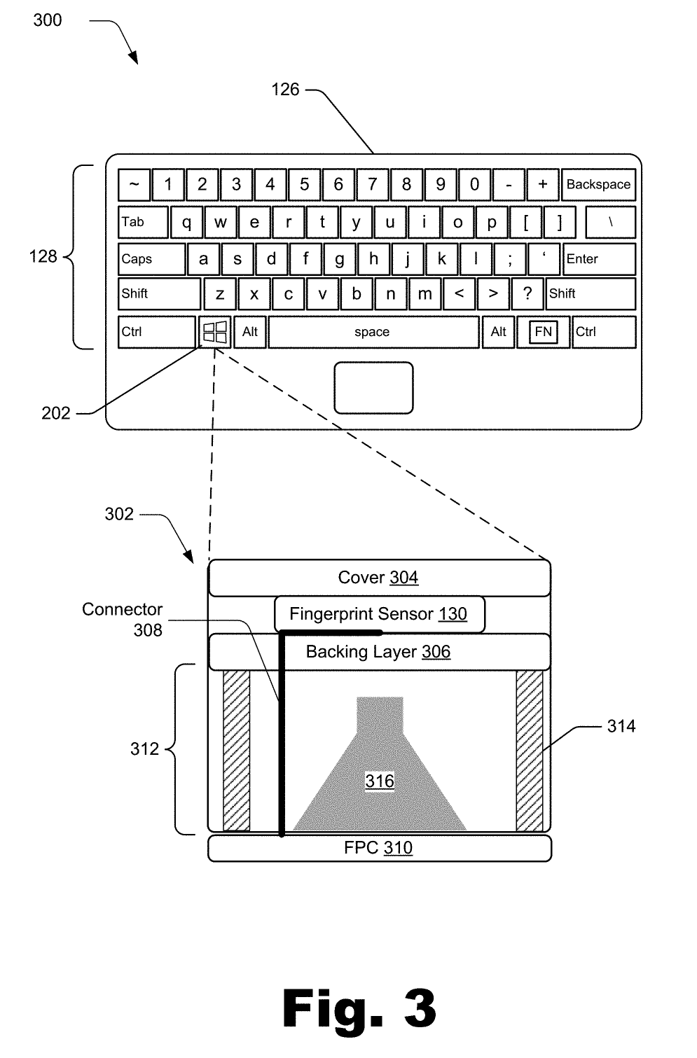

Example details and implementations of a sensor key are depicted and described in relation to FIGS. 3-6 below. In particular, FIG. 3 depicts generally at 300 details of a sensor key 202 included in a keyset assembly 128 for an input device 126 in accordance with one or more implementations. In this example, the input device 126 is a keyboard having a “qwerty” arrangement of keys, although other types of input devices and key arrangements are also contemplated. Additionally, the keyset assembly 128 includes a sensor key 202 within the arrangement of keys. For instance, the sensor key 202 is represented as being integrated into a logo or home key that is included in the key layout. The sensor key 202 may also be implemented by other keys such as the “f” key, the space bar, or the function key, to name a few examples. In this scenario, the sensor key 202 is a multifunction key designed to provide functionality for fingerprint sensing as well as other functions assigned to the key. The functionality provided by the key at any given time is selectively switched based on the current context. For instance, if a user is logging into the device or in the midst of a purchase transaction, the key operates for fingerprint sensing. On the other hand, during interaction with desktop applications to create or edit documents, the key is switched to provide input functionality associated with the key (e.g., navigate home, insert letter or space, etc.). By combining the sensor key 202 with another key in this manner, the number of keys overall as well as the size of the input device is reduced, which reduces component cost and enables thin and sleek device designs. Alternatively, the key may be dedicated to sensing. The dedicated sensor key may be actuated like a normal key to initiate sensing operations. Alternatively, the dedicated key may be configured as a fixed that does not travel. In this case, sensing occurs when a user places their finger on or in close proximity above the key surface of the fixed key.

FIG. 3 additionally depicts a cross-sectional view 302 of the sensor key 202 showing different components and layers employed to form the sensor key. In general, the sensor key 202 includes a cover 304, a backing layer 306, and fingerprint sensor 130 that together form a keycap for the sensor key.

The fingerprint sensor 130 may be configured in various ways. For example, the fingerprint sensor may be implemented via an integrated circuit (IC) die having a block of semiconducting material upon which a functional circuit is fabricated. Componentry of the fingerprint sensor 130 may be mounted to and interconnected via a substrate such as a rigid or flexible printed circuit board. In accordance with techniques described herein, the IC die includes functionality to implement a fingerprint sensor 130. The cover 304 is a surface layer for the key that is disposed “over-the-top” of the IC die. The backing layer 306 is located underneath the fingerprint sensor 130 to provide support and to isolate the fingerprint sensor 130 from underlying components and mechanisms of the sensor key. Thus, as depicted, the fingerprint sensor 130 is positioned between the cover 304 and the backing layer 306.

The cover 304 may be configured in various ways. The cover 304 is typically formed as a plastic or composite layer that protects the key and may include key indications (letters, numbers, logos). The cover 304 may also include painted and/or etched key indications. The cover 304 may also include patterns that are etched are otherwise formed into the cover 302. The cover may be configured to form a surface for the sensor key that covers the underlying fingerprint sensor. In this approach, the sensor key has an appearance that is consistent with other keys within the arrangement of keys, such that the sensor key “blends-in” and the embedded fingerprint sensor is not visible from the surface of the key. Thus, the cover 304 forms a relatively thin layer positioned over the fingerprint sensor 130. The cover 304 may be formed using an epoxy molding compound (EMC) layer that is molded around the fingerprint sensor 130. The depicted layers may also be formed as separate layers that are laminated together using adhesive.

As noted the cover is some implementations may be configured to include a cut-out portion positioned above the fingerprint sensor such that the fingerprint sensor within the key is exposed and visible through an opening formed by the cutout in the surface of the sensor key. Typically, operation of the fingerprint sensor 130 degrades as the thickness of material above the sensor increases. Consequently, exposing the fingerprint sensor through a cut-out in the keycap as described herein may lead to improved sensor performance.

The circuitry of the fingerprint sensor 130 is physically and communicatively coupled by way of a connector 308 to a flexible printed circuit (FPC) 310 or “system” board for the input device 126. The connector 308 may be implemented as a flex cable or other suitable connector to interconnect circuitry of the fingerprint sensor 130 with the FPC. The FPC 310 includes a matrix of conductive traces and circuitry operable to detect key presses and convert key presses into input signals for operation of the device. A wired or wireless connection of the input device 126 to the computing device is employed to convey the input signals for processing and handling by the input/output module 132, operating system, control logic of the input device, and/or other device functionality.

The sensor key further includes a component layer 312 that includes various mechanisms for operations of the key. The mechanisms included in the component layer 312 are configured to provide key response and key travel when the corresponding key is pressed. In implementations, the fingerprint sensor 130 operates to capture fingerprint data and initiate recognition processing responsive to actuation of the sensor key via the mechanisms in the component layer 312.

The component layer 312 is located generally underneath the keycap between the keycap and the FPC 310 for the input device (e.g., the system board). Mechanisms included in the component layer 312 include various switches, contacts, support structures, and devices that enable the key to work. In the depicted example, the key is configured as a scissor key and therefore includes a scissor switch structure 314 represented by two hatched areas. The key is depicted as additionally including a dome switch 316 that is spaced apart from the backing layer 306. We then key is depressed, the scissor switch structure 314 allows for key travel and then rebounding of the key. The key travel causes the backing layer 306 to contact the dome switch 316 and depress the dome switch to cause generation of a corresponding input signal. Generation of the input signal by the sensor key may initiate capture of fingerprint data and recognition processing in appropriate circumstances. In addition or alternatively, generation of the input signal may cause other actions based on the input context such as character entry, navigation control of a user interface, and other actions assigned to the key. Various other configurations of keys are contemplated, which may utilize different combinations of mechanisms including but not limited to scissor switches, mechanical switches, dome switches, capacitive touch pads, hall effect detectors, and other mechanisms.

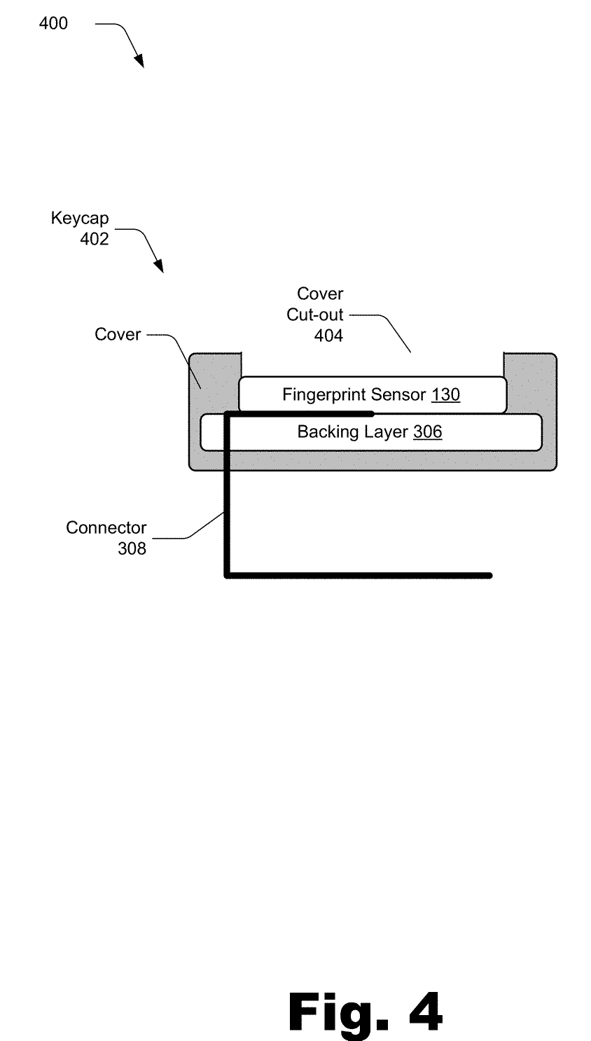

As just described, the example of FIG. 3 generally shows different components and layers employed to form the sensor key 202. In this context, it is noted that various different implementations of the sensor key 202 are contemplated which follow the general concepts discussed in relation to the example of FIG. 3. In particular, a keycap portion of a sensor key 202 that is consistent with the principles discussed may be configured in various ways. To illustrate, some representative example implementations of a keycap for the sensor key are now described in relation to FIGS. 4 to 6.

For instance, FIG. 4 depicts generally at 400 an example arrangement of a keycap 402 in accordance with one or more implementations. In this example, keycap 402 is formed using a cover 304 that has a cover cut-out 404. The cover cut-out 404 is configured as an open portion formed in the surface of the cover that exposes the underlying fingerprint sensor. For instance, the cover cut-out 404 may be formed as a rectangular shaped cut-out in the surface of the keycap 402. The cover cut-out 404 could also have other shapes such as a circular or oval shape. Here, the fingerprint sensor is exposed via the cover cut-out 404 and therefore the surface of the fingerprint sensor 130 is visible and forms the top surface of the keycap in the region of the cover cut-out 404. The cover cut-out 404 may remain open as depicted. Alternatively, the cover cut-out 404 made be filled or covered with a clear covering layer (not shown) of glass, plastic, or composite material disposed in a cut-out region formed by the cover cut-out 404. In this case, the fingerprint sensor 130 is visible through the clear covering layer and operates effectively through the clear covering layer.

As noted, exposing the fingerprint sensor 130 may improve performance since layers that could potentially interfere with sensing are either removed as in the depicted example of FIG. 4 or configured as a relatively thin layer of material (e.g., the clear cover layer) that does not substantially degrade sensing performance. A user's finger is placed directly in contact with the fingerprint sensor 130 through the cover cut-out 404 for recognition operations. It is also noted that the surface of the fingerprint sensor 130 may include a label or logo for the key disposed on a surface of the fingerprint sensor exposed via the cut-out. During fingerprint recognition, processing occurs to subtract out the label or logo leaving the candidate fingerprint pattern for matching to known templates.

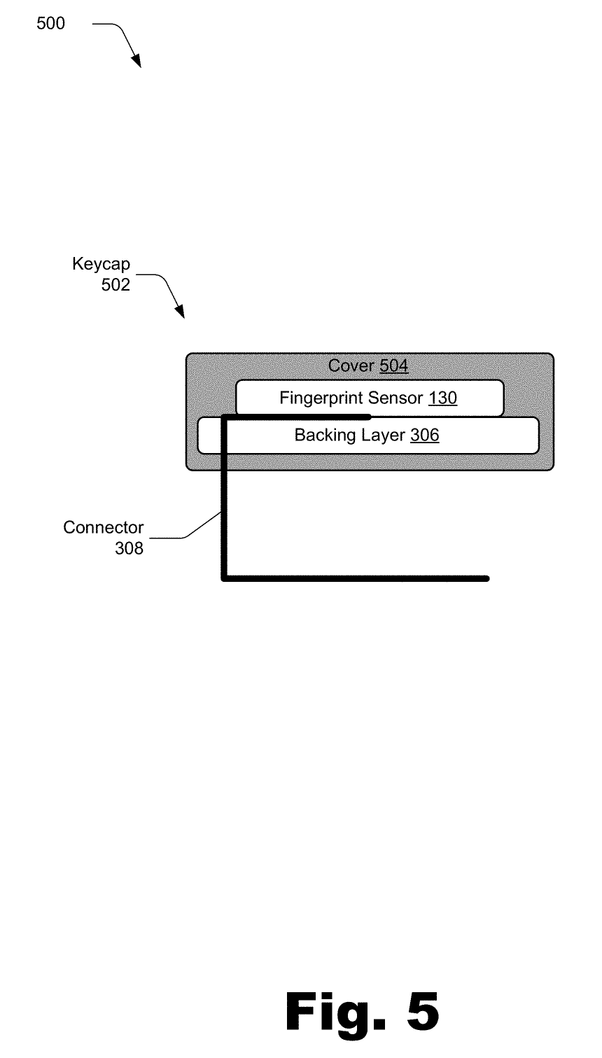

Referring to FIG. 5, another example arrangement of a keycap 502 in accordance with one or more implementations is depicted generally at 500. In this example, the keycap 502 is formed as an enclosed cap that covers the fingerprint sensor 130. In particular, the keycap 502 has a cover 504 that is disposed over the top of the fingerprint sensor 130 and backing layer 306. In this arrangement, the cover 504 may be a molded plastic, metal, or composite cap that is stacked above the fingerprint sensor 130. The cover 504 may be molded around the fingerprint sensor 130, such that the sensor is formed as part of the key cap itself. In other words, the fingerprint sensor 130 is implemented as a component that is embedded within the keycap 502. Here, the IC die or circuit implementing the fingerprint sensor 130 is designed and manufactured as a keycap. For example, the fingerprint sensor 130 dimensions may be increased (e.g., the size of the chip/IC die) and the sensor may be formed in a keycap shape so that the fingerprint sensor 130 may be used directly as a keycap for the sensor key. In other words, a separate assembly process to form the keycap from multiple components (e.g., a cover layer joined to an IC die) is not necessary in this approach.

Alternatively, the cover and fingerprint sensor 130 may be layers that are joined together using adhesive. In this approach, the fingerprint sensor 130 may be a separate chip or IC die that is manufactured separately from the cover 504. The cover 504 is then stacked over the fingerprint sensor 130 in the keycap assembly and the layers are laminated together using adhesive.

In either case, the cover 504 may be painted to match other keys in an arrangement of keys and may also include labels, logos, and/or other key indications. Consequently, the cover 504 conceals the underlying fingerprint sensor 130 such that the sensor is “invisible,” and the keycap 502 is designed to appear like other keys in an arrangement of keys so that the sensor key 202 “blends-in”. In implementations that employ the invisible sensor approach, the fingerprint sensor 130 is configured to operate reliably through the cover 504. In other words, the fingerprint sensor 130 used for the keycap 502 is capable of achieving satisfactory detection and recognition through the thickness of the cover 502. For example, the fingerprint sensor 130 may utilize ultrasonic sensing technology that operates satisfactorily through cover thickness of up to about 500 microns. In addition, or alternatively, the cover thickness may be minimized to facilitate sensing using ultrasonic as well as other fingerprint sensing technology. For example, the cover 504 may be designed to have a thickness of less than about 300 microns.

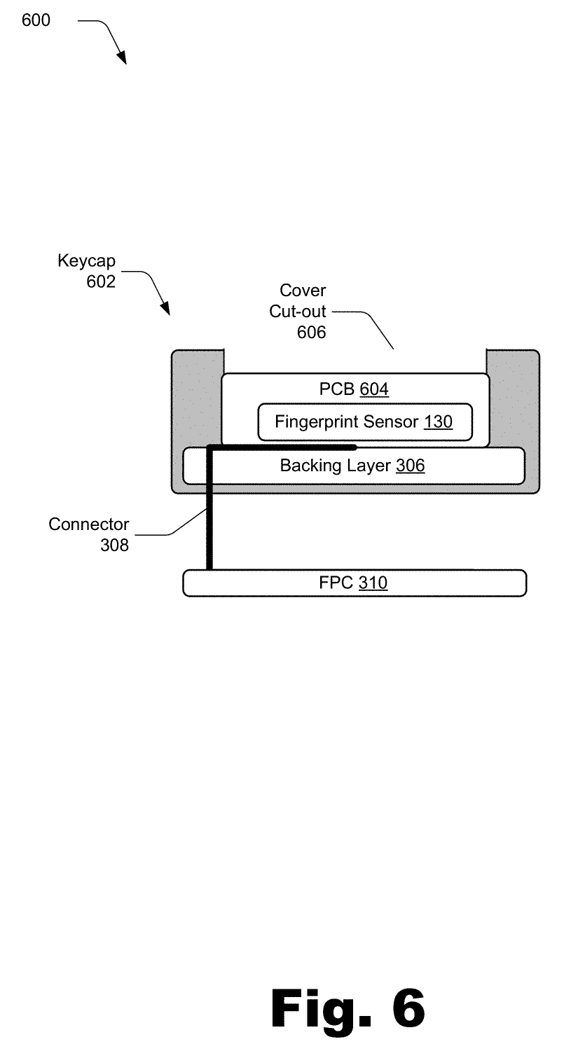

FIG. 6 depicts generally at 600 an additional example arrangement of a keycap 602 in accordance with one or more implementations. In this example, keycap 602 includes a fingerprint sensor 130 that is implemented via a printed circuit board (PCB) 604. For example, the fingerprint sensor 130 may be implemented via a rigid PCB upon which componentry for the fingerprint sensor 130 is disposed, such as an FR-4 PCB or other flame retardant glass-reinforced epoxy laminate. The PCB 604 is then connected to then connected to the underlying FPC 310 for the input device (e.g., the system board) via a connector 308 in the form of a flex PCB.

With the popularity of flexible printed circuits (FPC), many electronic components today are implemented using flex PCBs and popularity of rigid PCB based devices has diminished. In the case of fingerprint sensors 130 and keycaps described herein, PCB provide a simple and cost effective way to design a sensor key 202. The rigid PCB provides a solid structure for a keycap based fingerprint sensor 130. Additionally, the PCB is also easy to manufacture and has a lower cost relative to Flex PCBs. For example, mounting a fingerprint sensor 130 directly to a flex PCB may be difficult and time consuming leading to increased manufacturing cost and complexity. Although use of a rigid PCB such as an FR-4 board is represented in FIG. 6, various different approaches are contemplated and keycap designs may generally use rigid PCBs, flex PCBs, and/or combinations having both rigid PCBs and flex PCBs.

In the example of FIG. 6, the keycap 602 is represented as having a “visible” sensor that is located beneath a cover cut-out out 606 comparable to the example discussed in relation to FIG. 4. It is noted, however, that use of a fingerprint sensor 130 implemented via a PCB 604 is not limited to implementation having visible sensors. Rather, the PCB approach depicted and discussed in relation to FIG. 6 may be employed in conjunction with both visible and invisible sensor designs in accordance with the examples described throughout this document.

As noted, a backlight integrated with a keyset assembly may be provided to supply light for backlighting of the keyset including backlighting of the sensor key. Backlighting may be employed to selectively illuminate the sensor key in dependence upon the sensors status, current interaction scenario, and/or various corresponding criteria. Any suitable backlight arrangement may be employed in conjunction with the example keysets, sensor keys, and keycaps that include fingerprint sensors as described above and below.

In this context, FIG. 7 depicts generally at 700 an example backlight arrangement for keyset fingerprint sensors in accordance with one or more implementations. In particular, the FIG. 7 depicts a cross section view of keyset assembly having an example sensor key 202 that includes a fingerprint sensor 130 and a key 702 that is configured a standard key without a sensor. In the depicted example, the keys employ scissor mechanisms although other key mechanisms are contemplated. The backlight arrangement includes backlights 204 positioned in-between the keys. The backlights 204 are positioned to supply light to illuminate backlit plates 704 located underneath each key. The backlights 204 and backlit plates 704 are secured to a bracket 706 that provides a support structure for the assembly within a housing of a corresponding input device 126. Backlights 204 may be selectively turned on and off to illuminate corresponding keys. The backlights 204 may be operated individually (e.g., one at a time) or in combination (two or more lights switched on/off collectively). In the represented arrangement, the backlit plates 704 when illuminated, provide backlighting that is transmitted around the edges of keycaps for corresponding keys. Accordingly, the backlight is visible to a user around the perimeter of the keys. The backlights 204 are typically configured as a light emitting diode (LED) lights, although other types of lights may be employed in some scenarios.

In operation, a backlight 204 may be configured to selectively supply light at different times, in different colors, and/or in different sequences to illuminate the sensor key 202 and thereby provide indications indicative of sensing operations performed via the fingerprint sensor. Properties of the light that is provided by the backlight 204 may be adapted according to control logic implemented via the computing device 102 and/or a controller or fixed logic circuitry of the input device 126. In one approach, control circuitry of the input device 126 (e.g., logic for the key/light, or a controller or logic circuit for the input device) is operated under the influence of the operating system 108 to change the timing, color, and sequence of light emitted by the backlight 204 for different scenarios. Additional examples and details are discussed in relation the following example procedure.

Example Procedures

To further illustrate, consider the discussion in this section of example procedures and implementation details related to keyset fingerprint sensors with backlight. The procedures described in this document may be implemented utilizing the environment, system, devices, and components described herein and in connection with any suitable hardware, software, firmware, or combination thereof. The procedures may be represented as a set of blocks that specify operations performed by one or more entities and are not necessarily limited to the orders shown for performing the operations by the respective blocks.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

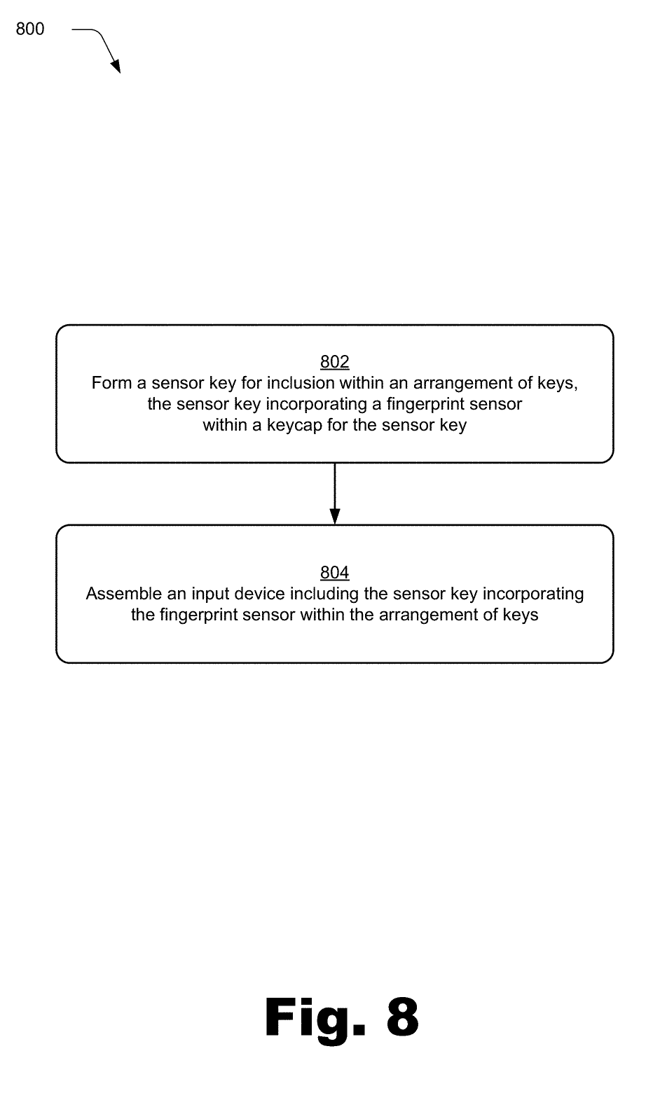

FIG. 8 depicts an example procedure 800 for assembly of an input device having a sensor key in accordance with one or more implementations. A sensor key for inclusion within an arrangement of keys is formed (block 802). In accordance with principles discussed herein, the sensor key incorporates a fingerprint sensor within a keycap for the sensor key. For example, a sensor key 202 as discussed herein may be formed in various ways. The sensor key 202 may be configured with various different types of keycaps in accordance with the foregoing examples. The sensor key 202 may be configured having a visible fingerprint sensor 130 as discussed in relation to FIG. 4. The sensor key 202 may alternatively be configured having an invisible fingerprint sensor 130 as discussed in relation to FIG. 5. In implementations, the fingerprint sensor 130 is implemented via a rigid PCB as described in relation to FIG. 6. However, flex PCBs and other types of components may also be used in addition to or in place of the rigid PCB.

An input device is assembled to include the sensor key incorporating the fingerprint sensor within the arrangement of keys (block 804). For example, various types of input devices 126 may employ sensor keys 202 in accordance with the techniques and examples described previously. The sensor key 202 includes a fingerprint sensor 130 operable to perform operations to recognize fingerprints and take corresponding actions to identify a user, control access to devices and content, initiate authentication sequences and so forth. In implementations, operations to capture and process fingerprints are triggered responsive to actuation of the sensor key 202. In other words, a user presses the key to explicitly initiate operation of the fingerprint sensor 130 for fingerprint recognition.

As also described in the foregoing description, an arrangement of keys may include backlights to provide backlighting. For example, a backlight arrangement as discussed in relation to the example of FIG. 7 may be employed. In this context, control logic may direct operation of a backlight to supply light indicative of a status of the fingerprint sensor. Different indications may be directed for different statuses by specifying variations for properties of the light supplied by the backlight including but not limited to one or more of the timing, color, and/or sequence of the light. In implementations, a data structure such as a file, table, database, or fixed logic may be configured to map different statuses to properties of light and/or control instructions used to indicate the status. The data structure is used to look-up properties and instructions that match a detected status. Then, the control logic associated with the sensor key 202 communicates control signals to cause the backlight to illuminate a corresponding key or keys to reflect the detected status as specified by the data structure. Varying the timing, color, sequence, and other properties of the light provides a mechanism to provide indications indicative of sensing operations performed via the fingerprint sensor, examples of which were previously discussed.

Having considered example details and procedures for keyset fingerprint sensors, consider a discussion of an example system in accordance with one or more implementations.

Example System and Device

FIG. 9 illustrates an example system generally at 900 that includes an example computing device 902 that is representative of one or more computing systems and/or devices that may implement the various techniques described herein. The computing device 902 may be, for example, be configured to assume a mobile configuration through use of a housing formed and size to be grasped and carried by one or more hands of a user, illustrated examples of which include a mobile phone, mobile game and music device, and tablet computer although other examples are also contemplated.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways to support user interaction.

The computing device 902 is further illustrated as being communicatively and physically coupled to an input device 914 that is physically and communicatively removable from the computing device 902. In this way, a variety of different input devices may be coupled to the computing device 902 having a wide variety of configurations to support a wide variety of functionality. In this example, the input device 914 includes one or more controls 916. The controls may be configured as pressure sensitive elements, buttons, a trackpad mechanically switched keys, and so forth.

The input device 914 is further illustrated as including one or more modules 918 that may be configured to support a variety of functionality. The one or more modules 918, for instance, may be configured to process analog and/or digital signals received from the controls 916 to recognize inputs and gesture, determine whether an input is indicative of resting pressure, initiate communication with a computing device, support authentication of the input device 914 for operation with the computing device 902, and so on. The input device 914 may also be configured to incorporate a keyset assembly 128 that includes a sensor key 202 and backlight 204 as previously described.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” refers to media and/or devices that enable persistent storage of information in contrast to mere signal transmission, carrier waves, or signals per se. Thus, computer-readable storage media does not include transitory media or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

### EXAMPLE IMPLEMENTATIONS

Example implementations of techniques described herein include, but are not limited to, one or any combinations of one or more of the following examples:

### Example 1

An input device comprising: a keyset assembly including an arrangement of keys; and a sensor key located as a key within the arrangement of keys including: a keycap having an integrated fingerprint sensor for fingerprint recognition; and a component layer having mechanisms for operation of the sensor key, wherein the fingerprint sensor operates to capture fingerprint data and initiate recognition processing responsive to actuation of the sensor key via the mechanisms in the component layer.

### Example 2

An input device as described in any one or more of the examples in this section, wherein the mechanisms comprises a scissor switch structure.

### Example 3

An input device as described in any one or more of the examples in this section, wherein the keycap includes a cover having a cover cut-out forming an open portion configured to expose the fingerprint sensor arranged underneath the cover as a top surface of the keycap.

### Example 4

An input device as described in any one or more of the examples in this section, wherein the keycap is formed as an enclosed cap that covers the fingerprint sensor such that the fingerprint sensor is concealed and the sensor key has an appearance that matches other keys in the arrangement of keys.

### Example 5

An input device as described in any one or more of the examples in this section, wherein the fingerprint sensor is implemented via an integrated circuit die that is adhered with adhesive to a cover for the keycap.

### Example 6

An input device as described in any one or more of the examples in this section, wherein the fingerprint sensor is formed in a keycap shape for direct use as the keycap for the sensor key.

### Example 7

An input device as described in any one or more of the examples in this section, wherein the fingerprint sensor is implemented via a rigid printed circuit board (PCB) that is connected to a system board for the input device via a flex printed circuit board (flex PCB).

### Example 8

An input device as described in any one or more of the examples in this section, further comprising a backlight positioned to supply light to illuminate a backlit plate located underneath the sensor key and thereby provide backlighting that is visible around edges of the keycap.

### Example 9

An input device as described in any one or more of the examples in this section, wherein the sensor key is configured as multifunctional key designed for use as a both a fingerprint sensor and as a key having other input functions.

### Example 10

An input device as described in any one or more of the examples in this section, wherein the input device comprises a keyboard device having a plurality of keys operable to generate input signals for operation of a computing device.

### Example 11

A sensor key included as a key within an arrangement of keys for an input device comprising: a keycap having a cover and an integrated fingerprint sensor for fingerprint recognition arranged underneath the cover, the cover including a cover cut-out forming an open portion to expose the fingerprint sensor as a top surface of the keycap; and a component layer located underneath the keycap having mechanisms to provide key response and key travel when the sensor key is pressed.

### Example 12

A sensor key as described in any one or more of the examples in this section, wherein a clear covering layer is disposed in a cut-out region formed by the cover cut-out, and the fingerprint sensor is configured to operate through the clear covering layer.

### Example 13

A sensor key as described in any one or more of the examples in this section, wherein the cover cut-out enables placement of a user's finger directly in contact with the fingerprint sensor for recognition operations.

### Example 14

A sensor key as described in any one or more of the examples in this section, wherein the fingerprint sensor operates to capture fingerprint data and initiate recognition processing responsive to actuation of the sensor key via the mechanisms in the component layer.

### Example 15

A sensor key as described in any one or more of the examples in this section, wherein a label for the sensor key is the disposed on a surface of the fingerprint sensor exposed via the cover cut-out.

### Example 16

A keyset assembly for an input device including: an arrangement of keys; and a sensor key positioned as a key within the arrangement of keys including:

a keycap including: a cover; and a printed circuit board (PCB) joined to the cover having componentry disposed thereon to implement a fingerprint sensor for fingerprint recognition; and a component layer underneath the keycap having mechanisms for operation of the sensor key, wherein the fingerprint sensor operates to capture fingerprint data and initiate recognition processing responsive to actuation of the sensor key via the mechanisms in the component layer.

### Example 17

A keyset assembly as described in any one or more of the examples in this section, wherein the cover includes a cut-out forming an open portion configured to expose the fingerprint sensor as a top surface of the keycap.

### Example 18

A keyset assembly as described in any one or more of the examples in this section, wherein the cover forms an enclosed cap that covers the fingerprint sensor such that the fingerprint sensor is concealed and the sensor key has an appearance that matches other keys in the arrangement of keys.

### Example 19

A keyset assembly as described in any one or more of the examples in this section, wherein the printed circuit board (PCB) comprises a flame retardant glass-reinforced epoxy laminate.

### Example 20

A keyset assembly as described in any one or more of the examples in this section, further comprising a connector implemented via a flex printed circuit board (flex PCB) configured to connect the printed circuit board (PCB) having the componentry to implement the fingerprint sensor to a system board of the input device.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. An input device comprising:
a keyset assembly including an arrangement of keys; and
a sensor key located as a key within the arrangement of keys including:
a keycap having an integrated fingerprint sensor for fingerprint recognition; and
a component layer having mechanisms for operation of the sensor key, wherein the fingerprint sensor operates to capture fingerprint data and initiate recognition processing responsive to actuation of the sensor key via the mechanisms in the component layer.

2. An input device as described in claim 1, wherein the mechanisms comprises a scissor switch structure.

3. An input device as described in claim 1, wherein the keycap includes a cover having a cover cut-out forming an open portion configured to expose the fingerprint sensor arranged underneath the cover as a top surface of the keycap.

4. An input device as described in claim 1, wherein the keycap is formed as an enclosed cap that covers the fingerprint sensor such that the fingerprint sensor is concealed and the sensor key has an appearance that matches other keys in the arrangement of keys.

5. An input device as described in claim 1, wherein the fingerprint sensor is implemented via an integrated circuit die that is adhered with adhesive to a cover for the keycap.

6. An input device as described in claim 1, wherein the fingerprint sensor is formed in a keycap shape for direct use as the keycap for the sensor key.

7. An input device as described in claim 1, wherein the fingerprint sensor is implemented via a rigid printed circuit board (PCB) that is connected to a system board for the input device via a flex printed circuit board (flex PCB).

8. An input device as described in claim 1, further comprising a backlight positioned to supply light to illuminate a backlit plate located underneath the sensor key and thereby provide backlighting that is visible around edges of the keycap.

9. An input device as described in claim 1, wherein the sensor key is configured as multifunctional key designed for use as a both a fingerprint sensor and as a key having other input functions.

10. An input device as described in claim 1, wherein the input device comprises a keyboard device having a plurality of keys operable to generate input signals for operation of a computing device.

11. A sensor key included as a key within an arrangement of keys for an input device comprising:
a keycap having a cover and an integrated fingerprint sensor for fingerprint recognition arranged underneath the cover, the cover including a cover cut-out forming an open portion to expose the fingerprint sensor as a top surface of the keycap; and
a component layer located underneath the keycap having mechanisms to provide key response and key travel when the sensor key is pressed.

12. A sensor key as described in claim 11, wherein a clear covering layer is disposed in a cut-out region formed by the cover cut-out, and the fingerprint sensor is configured to operate through the clear covering layer.

13. A sensor key as described in claim 11, wherein the cover cut-out enables placement of a user's finger directly in contact with the fingerprint sensor for recognition operations.

14. A sensor key as described in claim 11, wherein the fingerprint sensor operates to capture fingerprint data and initiate recognition processing responsive to actuation of the sensor key via the mechanisms in the component layer.

15. A sensor key as described in claim 11, wherein a label for the sensor key is the disposed on a surface of the fingerprint sensor exposed via the cover cut-out.

16. A keyset assembly for an input device including:
an arrangement of keys; and
a sensor key positioned as a key within the arrangement of keys including:
a keycap including:
a cover; and
a printed circuit board (PCB) joined to the cover having componentry disposed thereon to implement a fingerprint sensor for fingerprint recognition; and
a component layer underneath the keycap having mechanisms for operation of the sensor key, wherein the fingerprint sensor operates to capture fingerprint data and initiate recognition processing responsive to actuation of the sensor key via the mechanisms in the component layer.

17. A keyset assembly as described in claim 16, wherein the cover includes a cut-out forming an open portion configured to expose the fingerprint sensor as a top surface of the keycap.

18. A keyset assembly as described in claim 16, wherein the cover forms an enclosed cap that covers the fingerprint sensor such that the fingerprint sensor is concealed and the sensor key has an appearance that matches other keys in the arrangement of keys.

19. A keyset assembly as described in claim 16, wherein the printed circuit board (PCB) comprises a flame retardant glass-reinforced epoxy laminate.

20. A keyset assembly as described in claim 16, further comprising a connector implemented via a flex printed circuit board (flex PCB) configured to connect the printed circuit board (PCB) having the componentry to implement the fingerprint sensor to a system board of the input device.
